(19) United States
(12) Patent Application Publication
(10) Pub. No.: US 2009/0282653 A1
(43) Pub. Date: Nov. 19, 2009

(54) CORD LOCK

(75) Inventor: Yao-Ming Yang, Taichung City (TW)

Correspondence Address: NIFCO TAIWAN CORPORATION, P.O.BOX 108-00403, Taipei, 106, omitted

(73) Assignee: NIFCO TAIWAN CORPORATION, Taipei (TW)

(21) Appl. No.: 12/121,808

(22) Filed: May 16, 2008

(51) Int. Cl. F16G 11/00; E04H 15/64

(52) U.S. Cl. 24/129 R; 24/115 K

(57) ABSTRACT

A cord lock is disclosed having a front base, an insertion slot in the bottom side of a back sloping wall of the front base for the insertion of a fabric belt or rope, a rear locating block, two connection arms bilaterally connected between the front base and the rear locating block, an opening defined between the front base and the rear locating block in communication with the insertion slot, a transverse hanging block connected between the connection arms for the hanging of the fabric belt or rope that is inserted through the insertion slot, a bottom receiving open chamber defined in the bottom side of the rear locating block, and a through hole vertically cut through the rear locating block in communication with the bottom receiving open chamber for the passing of an end of the fabric belt or rope that is inserted through the insertion slot and hung on the transverse hanging block for enabling the end of the fabric belt or rope to be positioned in the bottom receiving open chamber with a locating member or a knot.

### BACKGROUND OF THE INVENTION

1. Field of the Invention

The present invention relates to cord locks and more particularly, to such a cord lock, which allows insertion and hanging of a fabric belt or rope for enabling one end of the fabric belt or rope to be positioned positively in a rear locating block thereof.

2. Description of the Related Art

Conventional belt buckles are commonly comprised of a male buckle member and a female buckle member for use to joint two flexible line members (belts or cords) that are respectively affixed to two parts of a device. These belt buckles are intensively used in shoes, pants, clothes, backpacks, travel bags, shoulder bags, safety helmets, bicycle accessories (water bottle, toolbox, storage box), recreational machines' or baby carts' safety belts, and many other devices. Further, a different design of buckle has a different engagement structure between the male buckle member and the female buckle member, and the related operation process to unlock the engagement structure is also different.

FIG. 6 illustrates a belt buckle according to the prior art. According to this design, the belt buckle is comprised of a male buckle member and a female buckle member. The male buckle member has a rear mounting portion for the fastening of one belt member and front retaining spring arms. The female buckle member has a rear mounting portion for the fastening of another belt member and a front receptacle for receiving the front retaining spring arms to secure the male buckle member in place. During installation, the mounting end of the cord member is inserted through insertion slots in the rear mounting portion of the male or female buckle member and then adjusted subject to the desired length. Because the excessive part of each belt member is exposed to the outside of the rear mounting portion of the male or female buckle member, it destructs the sense of beauty of the product. Further, the excessive part of each belt member may be stretched accidentally.

FIG. 7 illustrates a cord lock according to the prior art. According to this design, the cord lock comprises a button, a socket, and a spring member. The button is a stepped cylinder having a shank, a through hole transversely cut through the shank, two protruding blocks protruded from the periphery at two opposite sides and abutted against the bottom side of the through hole, and an extension rod axially extending from the distal end of the shank. The protruding blocks each have a flat top side and an arched bottom side. The socket comprises a cylindrical body shell, an open chamber defined in the cylindrical body shell, two through holes cut through the periphery of the cylindrical body shell and disposed in communication with the open chamber at two sides, a locating rod upwardly extending from the bottom wall of the cylindrical body shell and suspending in the open chamber, and two guide blocks inwardly protruded from the inside wall of the cylindrical body shell and respectively disposed above the through holes. The spring member is received in the open chamber and coupled between the locating rod and the extension rod. When inserting the button into the open chamber, the protruding blocks will be moved along the beveled blocks to the inside of the open chamber. When the user presses the button to compress the spring member, the through hole of the button is moved into axial alignment with the through holes of the socket for the insertion of a cord member. When the user releases the hand from the button, the spring member immediately pushes the button upwards to lock the cord member. This structure of cord lock is still not satisfactory in function. Because the cord lock and the inserted cord member extend in a crossed manner, the cylindrical cord lock cannot be kept closely attached with the periphery of the socket to the surface of the shoe, bag, or clothe carrying the cord member, destructing the sense of beauty of the article. Further, the user may feel uncomfortable when pressed the cord lock accidentally. In case the cord member is disconnected from the through hole of the button and the through holes of the socket accidentally, the parts of the cord lock may escape from one another. In this case, the user shall have to spend a lot of time to assemble the parts again. According to this design, the spring member is a coil spring. When pressing the button to compress the spring member, the spring member may be curved, causing vibration or tilting of the button. Further, this design of cord lock has a certain height, not suitable for low profile application. Further, during application of this design of cord lock, the excessive part of the cord member is exposed to the outside of the cord lock. The exposed excessive part of the cord member may be stretched accidentally, causing friction between the parts of the cord lock. Further, the exposed excessive part of the cord member may be jammed in a gap in the article (paints, bag, etc.) easily, causing damage.

Therefore, it is desirable to provide a cord lock that eliminates the drawbacks of the aforesaid prior art designs.

### SUMMARY OF THE INVENTION

The present invention has been accomplished under the circumstances in view. It is one object of the present invention to provide a cord lock, which has the end of the installed fabric belt or rope be kept from sight.

To achieve this and other objects of the present invention, the cord lock comprises a front base, the front base having a back sloping wall sloping backwardly downwards and an insertion slot in a bottom side of the back sloping wall, a rear locating block, two connection arms arranged in parallel and bilaterally connected between the front base and the rear locating block, an opening defined between the front base and the rear locating block in communication with the insertion slot, a transverse hanging block connected between the two connection arms and suspends in the opening at a top side, a bearing groove extending vertically on a front wall of the rear locating block and facing the opening, a bottom receiving open chamber defined in a bottom side of the rear locating block, and a through hole vertically cut through the rear locating block in communication with the bottom receiving open chamber. When in use, an end of the fabric belt or rope is inserted through the insertion slot and hung on the transverse hanging block, and then extending out of the insertion slot and then turned upwards over the rear side of the rear locating block for enabling the excessive part of the end of the fabric belt or rope to be tied in a knot and positioned in the bottom receiving open chamber or fastened to a locating member and received with the locating member in the bottom receiving open chamber.

### BRIEF DESCRIPTION OF THE DRAWINGS

FIG. 1 is an elevational view of a cord lock according to the present invention.

FIG. 2 is a sectional elevation of the cord lock according to the present invention.

FIG. 3 is a sectional side view of the cord lock according to the present invention.

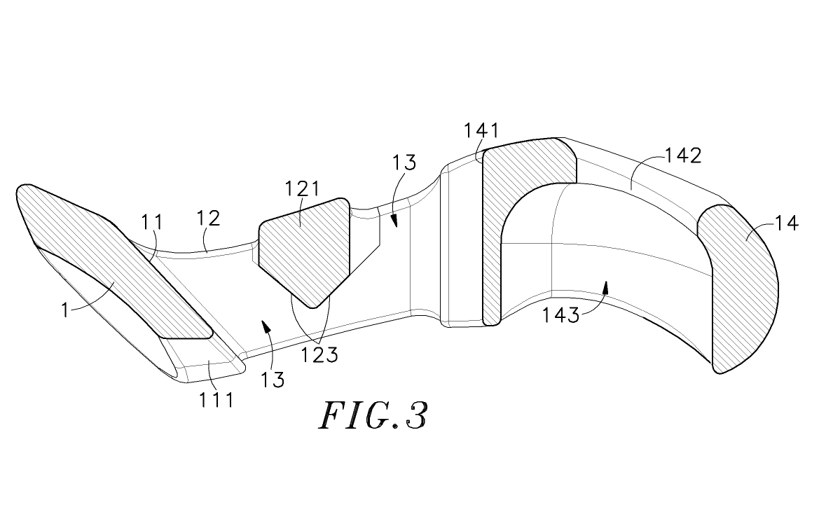

FIG. 4 is a schematic sectional side view of the present invention, showing one application example of the cord lock.

FIG. 5 is a schematic sectional side view of the present invention, showing another application example of the cord lock.

FIG. 6 is an exploded view of a belt buckle according to the prior art.

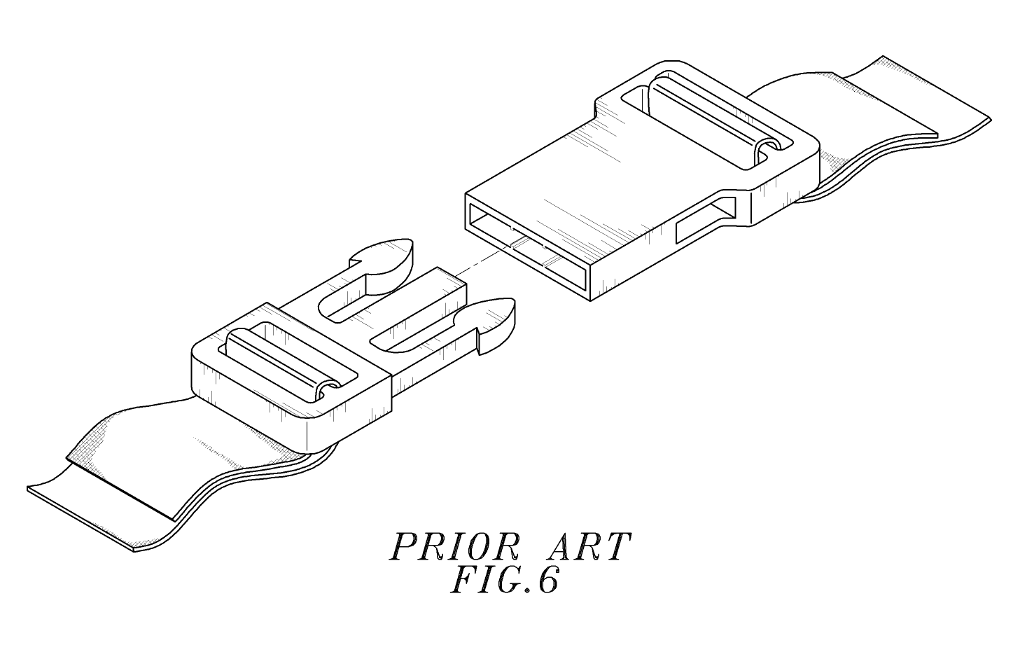

FIG. 7 is an exploded view of a cord lock according to the prior art.

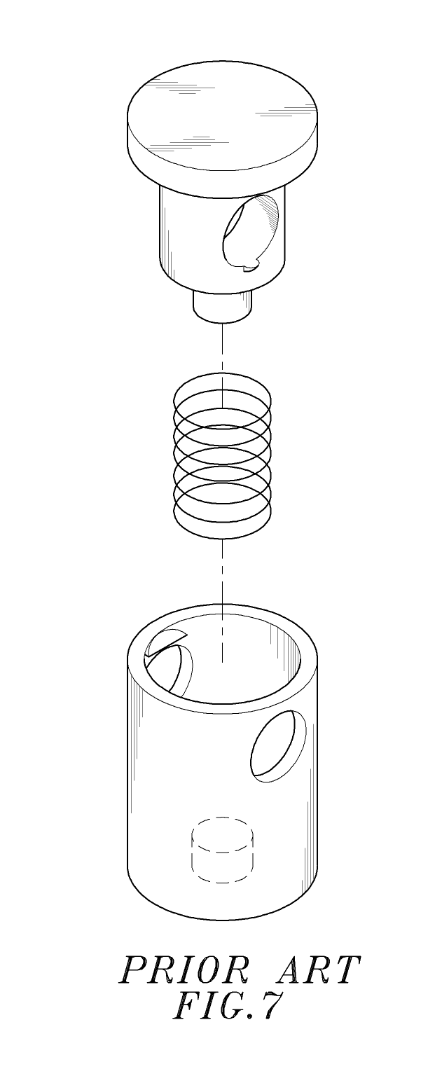

### DETAILED DESCRIPTION OF THE PREFERRED EMBODIMENT

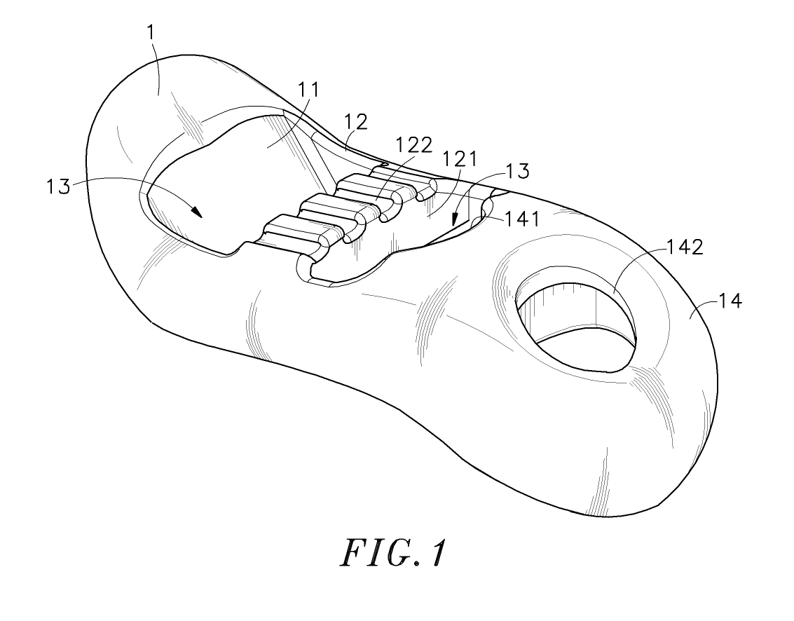

Referring to FIGS. 1˜4, a cord lock in accordance with the present invention is shown having an upwardly forwardly curving front base 1, which has a back sloping wall 11 sloping backwardly downwards and an arched insertion slot 111 in the bottom side, a rear locating block 14, which curves smoothly downwardly backwards, two connection arms 12 arranged in parallel and bilaterally connected between the front base 1 and the rear locating block 14, an opening 13 defined between the front base 1 and the rear locating block 14 in communication with the arched insertion slot 111, a transverse hanging block 121, which has a double-bevel bottom edge 123 and is connected between the two connection arms 12 and suspends in the opening 13 at a top side, a plurality of top locating grooves 122 arranged in parallel on the top surface of the transverse hanging block 121 and extending in direction from the front base 1 toward the rear locating block 14, a bearing groove 141 smoothly inwardly curved in transverse direction and extending vertically on the front wall of the rear locating block 14 and facing the opening 13, a bottom receiving open chamber 143 defined in the bottom side of the rear locating block 14, and a through hole 142 vertically cut through the rear locating block 14 in communication with the bottom receiving open chamber 143.

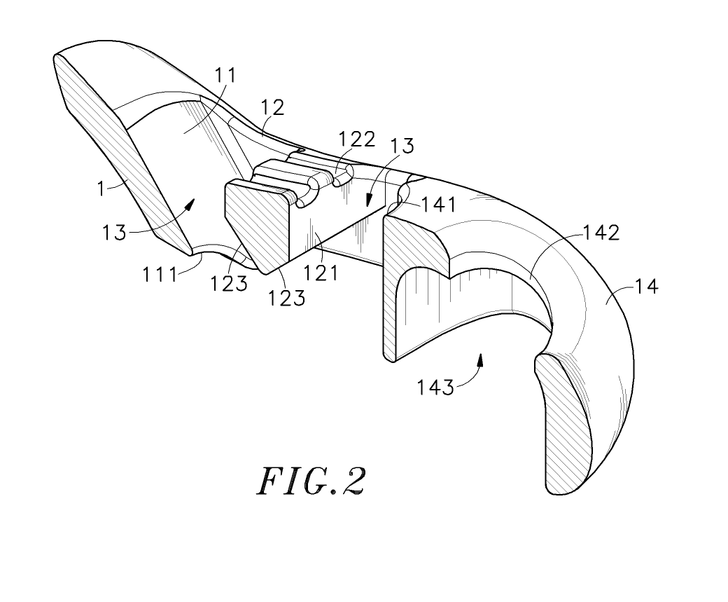

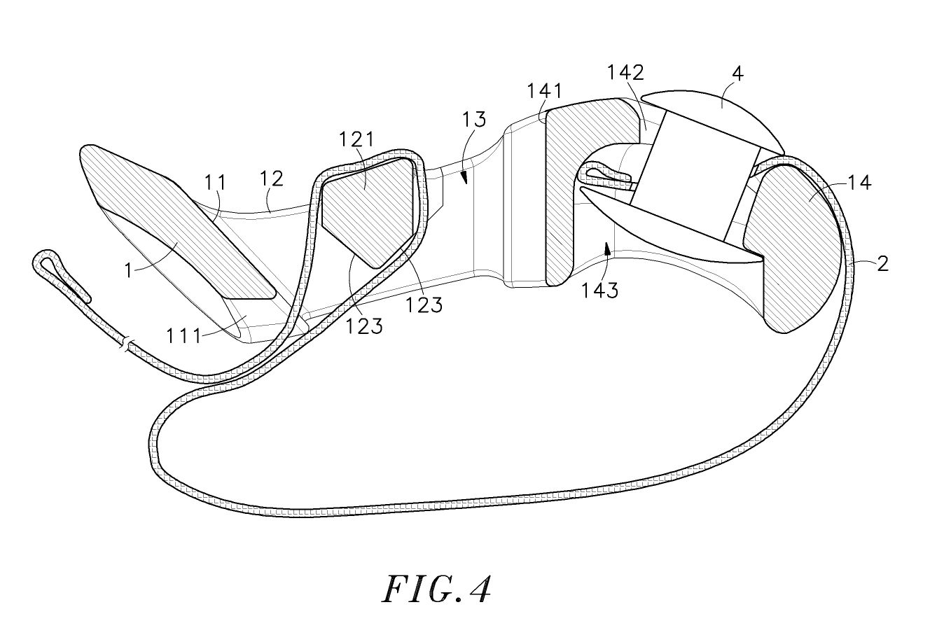

Referring to FIGS. 1, 2 and 4, a fabric belt 2 is inserted through the arched insertion slot 111 into the opening 13 and then extending over the top side of the transverse hanging block 121, and then extending downwards through the opening 13 to the outside of the cord lock, and then extending upwards over the rear locating block 14, and then fastened to a locating member 4, which is inserted through the through hole 142 and has its expanded top end positioned at the top side of the rear locating block 14 and its expanded bottom end positioned in the bottom receiving open chamber 143 below the through hole 142.

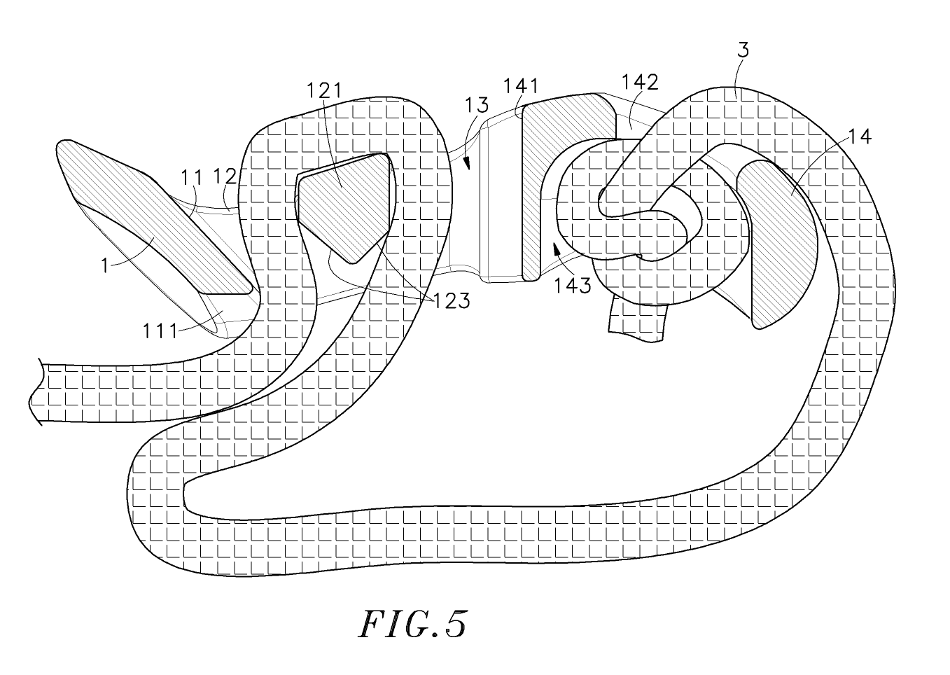

FIG. 5 shows another application example of the present invention. As shown in FIGS. 1, 2 and 5, a rope 3 is inserted through the arched insertion slot 111 into the opening 13 and then extending over the top side of the transverse hanging block 121 in close contact with the top locating grooves 122 of the transverse hanging block 121, and then extending downwards through the opening 13 to the outside of the cord lock, and then extending upwards over the rear locating block 14, and then inserted through the through hole 142 into the bottom receiving open chamber 143, and then tied in a knot that is received in the bottom receiving open chamber 143 and prohibited from passing through the through hole 142.

In the aforesaid two application examples, the top locating grooves 122 of the transverse hanging block 121 increase friction resistance between the fabric belt 2 or rope 3 and the transverse hanging block 121, avoiding sliding of the fabric belt 2 or rope 3 relative to the transverse hanging block 121.

When the cord lock is used with the fabric belt 2 or rope 3, the part of the fabric belt 2 or rope 3 between the transverse hanging block 121 and the rear locating block 14 is installed in the top or bottom of a pair of paints, a bag or any other article. After installation, the user can adjust the length of the part of the fabric belt 2 or rope 3 between the transverse hanging block 121 and the rear locating block 14, thereby adjusting the tightness of the part of the article that is surrounded by the fabric belt 2 or rope 3. Further, the smoothly curved bottom side of the cord lock can be closely attached to the surface of the article so that the part of the fabric belt 2 or rope 3 that is supported on the top side of the transverse hanging block 121 is evenly stretched in two reversed directions to impart a downward pressure to the cord lock against the article, preventing loosening of the fabric belt 2 or rope 3.

Further, the user can unfasten the fabric belt 2 from the locating member 4 or untie the knot in the end of the rope 3 that is received in the bottom receiving open chamber 143, and then tie up the excessive length of the fabric belt 2 or fasten the excessive length of the rope 3 to the locating member 4 to have the excessive length of the fabric belt 2 or rope 3 be received in the bottom receiving open chamber 143, keeping the excessive length of the fabric belt 2 or rope 3 from sight and preventing friction between the cord lock and the fabric belt 2 or rope 3.

As stated above, the invention provides a cord lock that comprises a front base 1, which has a back sloping wall 11 sloping backwardly downwards and an arched insertion slot 111 in the bottom side, a rear locating block 14, two connection arms 12 arranged in parallel and bilaterally connected between the front base 1 and the rear locating block 14, an opening 13 defined between the front base 1 and the rear locating block 14 in communication with the arched insertion slot 111, a transverse hanging block 121 connected between the two connection arms 12 in the opening 13, a bearing groove 141 extending vertically on the front wall of the rear locating block 14 and facing the opening 13, a bottom receiving open chamber 143 defined in the bottom side of the rear locating block 14, and a through hole 142 vertically cut through the rear locating block 14 in communication with the bottom receiving open chamber 143. The cord lock can be used with a fabric belt 2 or rope 3. The fabric belt 2 or rope 3 is inserted with its end through the arched insertion slot 111 over the transverse hanging block 121 for enabling the fabric belt 2 or rope 3 be hung on the transverse hanging block 121, and then the end of the fabric belt 2 or rope 3 is extended out of the bottom side of the cord lock over the rear side of the rear locating block 14 and then turned downwardly through the through hole 142 into the bottom receiving open chamber 143 and then secured thereto with a locating member 4 or by means of a knot.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A cord lock comprising a front base, said front base having a back sloping wall sloping backwardly downwards and an insertion slot in a bottom side of said back sloping wall, a rear locating block, two connection arms arranged in parallel and bilaterally connected between said front base and said rear locating block, an opening defined between said front base and said rear locating block in communication with said insertion slot, a transverse hanging block connected between said two connection arms and suspends in said opening at a top side, a bearing groove extending vertically on a front wall of said rear locating block and facing said opening, a bottom receiving open chamber defined in a bottom side of said rear locating block, and a through hole vertically cut through said rear locating block in communication with said bottom receiving open chamber.

2. The cord lock as claimed in claim 1, wherein said front base curves upwardly forwards.

3. The cord lock as claimed in claim 1, wherein said insertion slot is smoothly arched; said bearing groove curves smoothly inwards in transverse direction.

4. The cord lock as claimed in claim 1, wherein said transverse hanging block has a plurality of top locating grooves arranged in parallel on a top surface thereof.

5. The cord lock as claimed in claim 1, wherein said transverse hanging block has a double-bevel bottom edge.

6. The cord lock as claimed in claim 1, wherein said rear locating block has a rear side curving smoothly downwards.

7. The cord lock as claimed in claim 1, wherein further comprising a locating member inserted through said through hole of said rear locating block and positioned in said bottom receiving open chamber to secure an end of a fabric belt or rope.

8. The cord lock as claimed in claim 1, which is used with a fabric belt or rope that inserted through said insertion slot and hung on said transverse hanging block and extending with an end thereof upwardly over said rear locating block through said through hole into said bottom receiving open chamber and tied in a knot for enabling said knot to be positioned in said bottom receiving open chamber.
